(19) United States
(12) Patent Application Publication
(10) Pub. No.: US 2025/0045500 A1
(43) Pub. Date: Feb. 6, 2025

(54) METHOD AND SYSTEM FOR PREDICTING FLOATING TIMES OF INCLUDSIONS DURING REFININEMENTS OF MOLTEN STEEL

(71) Applicants: North China University of Technology, Beiiing (CN); University of Science and Technology Beijing, Beijing (CN)

(72) Inventors: Lifeng Zhang, Beiiing (CN); Haojian Duan, Beiiing (CN); Jujin Wang, Beiiing (CN); Yuexin Zhang, Beiiing (CN); Qilan Li, Beiiing (CN); Ying Ren, Beiiing (CN); Wen Yang, Beiiing (CN); Wei Chen, Beiiing (CN)

(21) Appl. No.: 18/786,644

(22) Filed: Jul. 29, 2024

(30) Foreign Application Priority Data
Jul. 31, 2023 (CN) 2023109557664

(51) Int. Cl. G06F 30/28; G06F 111/10; G06F 113/08

(52) U.S. Cl. CPC G06F 30/28; G06F 2111/10; G06F 2113/08

(57) ABSTRACT

A method for predicting floating times of inclusions during refinements of molten steel includes: predicting a macroscopic multiphase flow field of the molten steel refining, injecting the inclusions into the multiphase flow field uniformly and randomly, determining a capture condition of the inclusions, calculating motion trajectories of the inclusions injected into the multiphase flow field, outputting captured inclusions' information through comparing the motion trajectory of the inclusion and the capture condition, and obtaining an average floating time, a relationship between a removal rate and the floating time, and the complete floating time through analyzing the captured inclusions' information. This method not only considers physical properties and sizes of the inclusions themselves but is also closely related to the refining process and the flow field in the refinement, and the results can provide theoretical basis for quantitative evaluation and optimization of the refining process and its parameters.

### TECHNICAL FIELD

The disclosure relates to the field of high-quality steel smelting technologies, and particularly to a method and system for predicting floating times of inclusions during refinements of molten steel.

### BACKGROUND

High-quality steel materials are key foundational materials for China's manufacturing industry, with particularly stringent requirements for cleanliness. The quality defects caused by insufficient cleanliness are still a problem that needs to be solved in the production of high-quality steel materials. The removal of inclusions directly determines the cleanliness of molten steel, therefore, studying the removal behavior of inclusions during refinements of molten steel is of great significance.

During the refinements of molten steel, the adsorption and dissolution by refining slag is the main way to remove inclusions from the molten steel. It is generally believed that the removal of inclusions by refining slag mainly includes three steps: 1) inclusions float up from the bulk of the molten steel to the steel-slag interface, 2) inclusions separate at the steel-slag interface, and 3) inclusions dissolve in the slag. At present, research on the removal of inclusions during the refinements of molten steel mainly discusses the removal rate of inclusions corresponding to different refining times, which is a general concept. However, for a specific refining process, there is little mention of how long it takes for different inclusions to float from the bulk of the molten steel to the steel-slag interface. Therefore, it is necessary to clarify the time required for inclusions to float from the bulk of the molten steel to the steel-slag interface. It is generally believed that the floating velocity of inclusions in the molten steel is the Stokes's floating velocity, which can be used to estimate the time it takes for inclusions to float from the bulk of the molten steel to the steel-slag interface. However, it should be pointed out that the Stokes floating velocity is applicable to static or Stokes's flow states, while the actual refinement of the molten steel is mostly turbulent flow with strong stirring. Therefore, it is necessary to clarify the time required for different types and sizes of inclusions to float from the bulk of the molten steel to the steel-slag interface for different refining processes of molten steel.

### SUMMARY

The present disclosure discloses a method and system for predicting floating times of inclusions during refinements of molten steel, in order to solve any of the above-mentioned and potential problems in the related art.

In order to achieve above purposes, the technical solution provided by the present disclosure is as follows. A method for predicting floating times of inclusions during refinements of molten steel, specifically includes following steps:
S1, predicting a macroscopic multiphase flow field during refinements of the molten steel;
S2, injecting the inclusions into molten steel uniformly and randomly, according to the calculated multiphase flow field in the S1;
S3, determining a capture condition of the inclusions injected into the multiphase flow field in the S2;
S4, calculating a motion trajectory of each inclusion injected into the multiphase flow field in the S2;
S5, outputting information of captured inclusions and removing the captured inclusions, when the motion trajectories of the inclusions in the S4 meet the capture condition of the inclusions in the S3; and
S6, analyzing the information of the captured inclusions obtained in the S5 to obtain an average floating time, a relationship between a removal rate and a floating time, and a complete floating time.

In an embodiment, the method further includes: updating, based on the average floating time and the complete floating time, process parameters (e.g., the arrangement of porous plugs and the gas flow rate) to obtain updated process parameters, and performing molten steel refining based on the updated process parameters; and/or determining, based on the relationship between the removal rate and the floating time, a refining time of the molten steel, thereby guiding on-site production.

In an embodiment, the S1 specifically includes following steps:
S1.1, determining a refining process of the molten steel (also referred to as the process of the refinement of the molten steel);
S1.2, obtaining process parameters and operating parameters, such as a ladle structure, a gas flow rate, etc.;
S1.3, determining physical parameters of phases of molten steel, refining slag, air and argon;
S1.4, establishing a multiphase flow model during refinement of the molten steel, where the multiphase flow model includes at least a molten steel phase and a refining slag phase; and
S1.5, solving the multiphase flow model through a computational fluid dynamic software to calculate and obtain the macroscopic multiphase flow field, where flow field data of the macroscopic multiphase flow field includes at least a velocity, a turbulent energy, a dissipation rate of the turbulent energy, and volume fractions of the molten steel phase and the refining slag phase.

In an embodiment, the refining process of the molten steel in the S1.1 includes: argon-stirred ladle, ladle furnace (LF) refining, ruhrstahl heraeus (RH) refining, or vacuum degassing (VD) refining.

In an embodiment, the S2 specifically includes following steps:
S2.1, obtaining regions of the molten steel phase in the macroscopic multiphase flow field during the refinement of the molten steel;
S2.2, determining a density and a diameter of the inclusions injected into the molten steel phase;
S2.3, determining a number N of the inclusions injected into the molten steel phase, where 10⁴<N<10⁵; and
S2.4, injecting the inclusions into the molten steel in the macroscopic multiphase flow field randomly and uniformly through programming, and taking this time as an initial time, t₀=0.

In an embodiment, the step of determining a capture condition of the inclusions injected into the multiphase flow field in the S3 specifically includes: when the volume fraction of the slag phase in a cell or a grid where the inclusion is located is greater than 0.5, the inclusion is determined to be captured by the refining slag.

In an embodiment, the S4 specifically includes following steps:
S4.1, taking random and uniform distribution of the inclusions in the molten steel phase in the S2.4 as an initial condition to calculate the motion trajectory of each inclusion in the multiphase flow field during the refinement of the molten steel;
S4.2, utilizing a discrete phase model to calculate the motion trajectory of each inclusion, and a motion equation of the inclusions being expressed by Newton's second law in the discrete phase model; solving an acceleration of each inclusion through forces acted on each inclusion, including a gravity, a buoyancy, a drag force, a virtual mass force, and a pressure gradient force; and describing influences of turbulences by a random walk model in the motion equation of the inclusions during the refinement of molten steel;
S4.3, integrating the acceleration of each inclusion solved in the S4.2 over time to obtain a velocity of each inclusion; and
S4.4, integrating the velocity of each inclusion obtained in the S4.3 to obtain a position of each inclusion; and connecting position points of each inclusion at different times to obtain the motion trajectory of each inclusion.

In an embodiment, the S5 specifically includes following steps:
S5.1, obtaining a volume fraction of a slag phase in the position of each inclusion calculated in the S4.4;
S5.2, comparing the volume fraction of the slag phase in the position of each inclusion obtained in the S5.1 and a volume fraction (i.e., 0.5) of the slag phase determined in the S3;
S5.3, making the inclusion enter a next time step when the volume fraction of the slag phase in the position of the inclusion obtained in the S5.1 is no greater than 0.5;
S5.4, determining the inclusion being captured by the refining slag when the volume fraction of the slag phase in the position of the inclusion obtained in the S5.1 is greater than 0.5, and taking this time as a floating time of the inclusion, denoted as t;
S5.5, recording and outputting relevant information of the inclusions captured by the refining slag, where the relevant information of the inclusions captured by the refining slag includes initial positions of the inclusions, captured positions of the inclusions, and the floating times of the inclusions; and
S5.6, removing the inclusions captured by the refining slag from a computational domain.

In an embodiment, the S6 specifically includes following steps:
S6.1, performing arithmetic average on the floating times of all of the inclusions to obtain an average floating time tₐᵥₑ through the following formula:

$${t}_{ave} = \frac{1}{N} {\sum }_{i = 1}^{N} {t}_{i} ;$$

where N represents a number of the inclusions, tᵢ represents a floating time of an i-th inclusion;
S6.2, letting M=N×m % when the removal rate of the inclusions is m %;
S6.3, sorting the floating times of all inclusions from smallest to largest to obtain a sequence Row;
S6.4, determining a floating time t_{m %} corresponding to the removal rate m % as a M-th value of the sequence Row, which is:

$${t}_{m \%} = Row [ M ] ;$$

S6.5, due to the randomness of the turbulence effect in the calculation process, determining the complete floating time tₐₗ as a floating time corresponding to a removal rate of 99%, which is:

$${t}_{al} = {t}_{99 \%} .$$

Another purpose of the present disclosure is to provide a system implementing the method for predicting floating times of inclusions during refinements of molten steel as described above, and the system includes:
a molten steel refining multiphase flow module, configured to predict the macroscopic multiphase flow field during the refinement of molten steel;
an inclusion floating motion analysis module, configured to calculate the motion trajectories of the inclusions and capture process of the inclusions according to the macroscopic multiphase flow field in the molten steel refining, and to output the information of the captured inclusions in the meanwhile; and
a data analysis module, configured to calculate and obtain the average floating time, the relationship of the removal rate and the floating time, and the complete floating time according to the information of the captured inclusions.

The molten steel refining multiphase flow module is embodied by software stored in at least one memory and executable by at least one processor; the inclusion floating motion analysis module is embodied by software stored in at least one memory and executable by at least one processor; and the data analysis module is embodied by software stored in at least one memory and executable by at least one processor.

Still another purpose of the present disclosure is to provide a computer-readable storage medium, the computer-readable storage medium is stored with a computer program, and the computer program is configured to be executed by a processor to implement the method for predicting floating times of the inclusions during the refinement of molten steel. The computer-readable storage medium is the non-transitory computer-readable storage medium.

The beneficial effects of the present disclosure are as follows: by adopting the above technical solutions, the present disclosure can calculate the average floating time of the inclusions in the molten steel, the relationship between the removal rate and the floating time, and the complete floating time by solving the motion trajectories of the inclusions during the refinement of molten steel and comparing the motion trajectory of each inclusion with the condition that the inclusions are captured by the steel-slag interface, and then recording and outputting the relevant information of the inclusions captured by the refining slag. In the present disclosure, the floating time of the inclusions is not only related to the physical properties and sizes of the inclusions themselves but is also closely related to the refining process and the flow field in the refinement. The average floating time and the complete floating time of the inclusions calculated by the present disclosure can provide a theoretical basis for the quantitative evaluation and optimization of the refining process and its parameters. Furthermore, the relationship curve between the removal rate and the floating time calculated by the present disclosure can serve as a guide for on-site production, thereby determining the refining time of the molten steel and optimizing production practices.

### BRIEF DESCRIPTION OF DRAWINGS

FIG. 1 illustrates a flowchart of a method for predicting floating times of inclusions during refinements of molten steel according to an embodiment of the present disclosure.

FIG. 2 illustrates a logical block diagram of a system for predicting floating times of inclusions during the refinements of molten steel according to an embodiment of the present disclosure.

FIG. 3 illustrates a calculated schematic diagram of a multiphase flow velocity field at an Ar flow rate of 3.0 m³/h according to the embodiment of the present disclosure.

FIG. 4 illustrates a calculated schematic diagram of a multiphase flow velocity field at an Ar flow rate of 6.0 m³/h according to the embodiment of the present disclosure.

### DETAILED DESCRIPTION OF EMBODIMENTS

The following will provide a clear and complete description of the technical solution of the present disclosure in conjunction with the embodiments. Apparently, the described embodiments are a part of the embodiments of the present disclosure, not all of them. Based on the embodiments of the present disclosure, all other embodiments obtained by relevant those skilled in the art without creative labor fall within the scope of protection of the present disclosure.

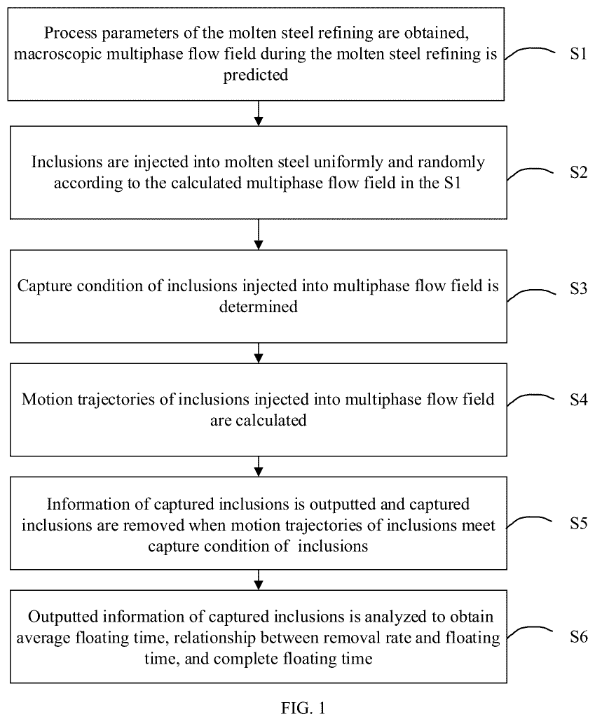

As illustrated in FIG. 1, a method for predicting floating times of inclusions during the refinement of molten steel, specifically includes the following steps S1 to S6.

S1, a macroscopic multiphase flow field during the refinement of molten steel is predicted.

S2, inclusions are injected uniformly and randomly into the molten steel according to the calculation obtained multiphase flow field in the S1.

S3, a capture condition of the inclusions injected into the multiphase flow field in the S2 is determined.

S4, a motion trajectory of each inclusion injected into the multiphase flow field in the S2 is calculated.

S5, when the motion trajectories of the inclusions in the S4 meet the capture condition of the inclusions in the S3, information of captured inclusions are outputted and the captured inclusions are removed.

S6, the information of the captured inclusions in the S5 is analyzed to obtain an average floating time, a relationship between a removal rate and the floating time, and a complete floating time.

The S1 specifically includes the following steps S1.1 to S1.5.

S1.1, a process is determined, which can be common refining processes such as argon-stirred ladle, LF refining, RH refining, VD refining, etc.

S1.2, process parameters and operating parameters such as the ladle structure, gas flow rate are determined.

S1.3, physical parameters of phases of the molten steel, refining slag, air, and argon, such as density, viscosity, etc. are determined.

S1.4, a multiphase flow model during refinement of molten steel is established, which may include at least a molten steel phase and a refining slag phase.

S1.5, the multiphase flow model is solved using a computational fluid dynamic software to calculate the macroscopic multiphase flow field during the refinement. Flow field data may include at least a velocity, a turbulent energy, a dissipation rate of the turbulent energy, and volume fractions of the molten steel phase and the refining slag phase.

The S2 specifically includes the following steps S2.1 to S2.4.

S2.1, specific regions of the molten steel phase in the macroscopic multiphase flow field during the molten steel refining are obtained.

S2.2, a density and a diameter of the inclusions to be injected into the molten steel phase are determined.

S2.3, the number N of the inclusions injected into the molten steel phase are determined, where 10⁴<N<10⁵.

S2.4, the inclusions are uniformly and randomly injected into the molten steel phase in the macroscopic multiphase flow field through programming, and this time is taken as an initial time, t₀=0.

The capture condition of the inclusions in the multiphase flow field determined in the S3 specifically includes: when the volume fraction of the slag phase in a cell or a grid where the inclusion is located is greater than 0.5, the inclusion is determined to be captured by a refining slag.

The S4 specifically includes the following steps S4.1 to S4.4.

S4.1, random and uniform distribution of the inclusions in the molten steel phase in the S2.4 is taken as an initial condition, the motion trajectory of each inclusion in the multiphase flow field during the refinement of the molten steel is calculated.

S4.2, the motion trajectory of each inclusion is calculated using a discrete phase model. In the discrete phase model, a motion equation of the inclusions is expressed by Newton's second law. An acceleration of each inclusion is solved by forces acted on each inclusion, including a gravity, a buoyancy, a drag force, a virtual mass force, and a pressure gradient force. Meanwhile, influences of turbulences are described by a random walk model in the motion equation of the inclusions during the refinement of molten steel.

S4.3, the acceleration of inclusions solved in the S4.2 is integrated over time to obtain a velocity of each inclusion.

S4.4, the velocity of the inclusions obtained in the S4.3 is integrated over time to obtain a position of each inclusion. A connection line of the positions of each inclusion at different time represents the motion trajectory of each inclusion.

The S5 specifically includes the following steps S5.1 to S5.6.

S5.1, the volume fraction of the slag phase in the position of each inclusion calculated in the S4.4 is obtained.

S5.2, the volume fraction of the slag phase in the position of each inclusion obtained in the S5.1 is compared with the volume fraction (i.e., 0.5) of the slag phase determined in the S3.

S5.3, when the volume fraction of the slag phase in the position of the inclusion obtained in the S5.1 is no greater than 0.5, the inclusion is made to enter a next time step.

S5.4, when the volume fraction of the slag phase in the position of the inclusion obtained in the S5.1 is greater than 0.5, the inclusion is determined to be captured by the refining slag (that is, the inclusion captured by the refining slag is the captured inclusion). This time is taken as a floating time of the inclusion, denoted as t.

S5.5, relevant information of the inclusions captured by the refining slag is recorded and outputted, including the initial position of the inclusions, captured positions of the inclusions, the floating times of the inclusions, etc.

S5.6, the inclusions captured by the refining slag are removed from a computational domain.

The S6 specifically includes the following steps S6.1 to S6.5.

S6.1, the floating times of all of the injected inclusions are arithmetically averaged to obtain an average floating time tₐᵥₑ through the following formula:

$${t}_{ave} = \frac{1}{N} {\sum }_{i = 1}^{N} {t}_{i} ;$$

where N represents the number of the inclusions, tᵢ represents a floating time of an i-th inclusion.

S6.2, when the removal rate of the inclusions is m %, let M=N×m %.

S6.3, the floating times of all of the injected inclusions are arranged from smallest to largest to obtain a sequence Row.

S6.4, a floating time t_{m %} corresponding to a removal rate m % is a M-th value of the sequence Row, which is:

$${t}_{m \%} = Row [ M ] .$$

S6.5, due to the randomness of the turbulence effect in the calculation process, the complete floating time tₐₗ is determined as a floating time corresponding to a removal rate of 99%, which is:

$${t}_{al} = {t}_{99 \%} .$$

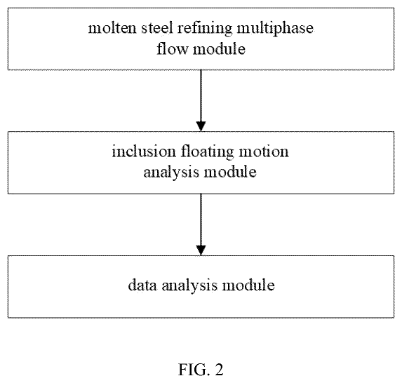

As illustrated in the FIG. 2, the present disclosure provides a system implementing a method for predicting floating times of inclusions during refinements of molten steel. The system includes: a molten steel refining multiphase flow module, an inclusion floating motion analysis module, and a data analysis module.

The molten steel refining multiphase flow module is configured to predict the macroscopic multiphase flow field during the refinement of molten steel.

The inclusion floating motion analysis module is configured to calculate the motion trajectories of the inclusions and capture process of the inclusions according to the macroscopic multiphase flow field during the refinement of molten steel. Meanwhile, the inclusion floating motion analysis module is also configured to output the information of the captured inclusions.

The data analysis module is configured to calculate and obtain the average floating time, the relationship of the removal rate and the floating time, and the complete floating time according to the information of the captured inclusions.

A computer-readable storage medium is provided, which is stored with a computer program. The computer program is executed by a processor to implement the method for predicting floating time of inclusions during the refinement of molten steel described above.

### Embodiment 1

This embodiment mainly focuses on a calculating method of floating times of small-sized alumina inclusions during argon stirring refinement in a ladle (also referred to as argon-stirred ladle, abbreviated as ASL), specifically the method includes following steps (as illustrated in FIG. 1).

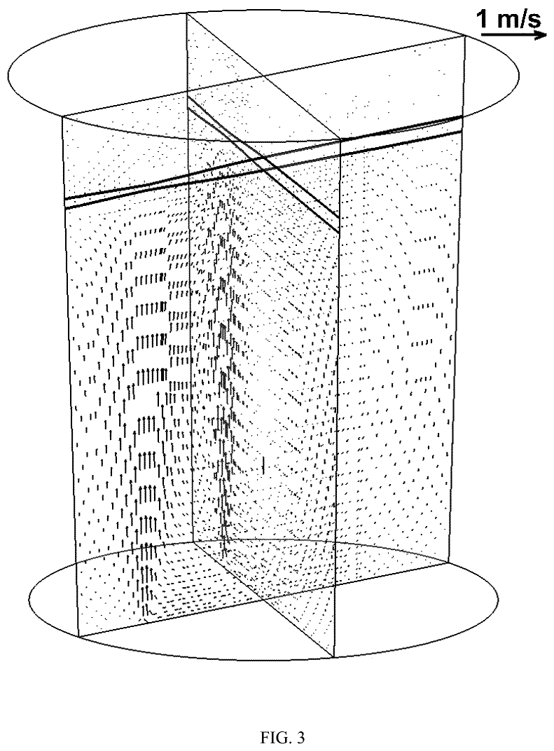

S1, a macroscopic multiphase flow field in molten steel defining is predicted. The molten steel refining process is the ASL. Specifically, process parameters and operating parameters are as follows: an upper opening diameter of the ladle is 3.92 meters (m), a lower bottom diameter of the ladle is 3.56 m, a height of the ladle is 4.17 m, a height of the molten steel is 3.42 m, a thickness of the refining slag is 0.1 m, coordinates of argon blowing locations are (0.9, 0.7) m and (0.3, −0.95) with two porous plugs, a flow rate of the argon is 3.0 cubic meters per second (m³/s) per porous plug, and a porous plug diameter is 0.1 m. Physical parameters are as follows: the density, viscosity, and surface tension of the molten steel are 7020 kilograms per cubic meter (kg/m³), 0.0067 Pascal·second (Pa·s), and 1.606 Newton per meter (N/m) respectively, the density, viscosity, and surface tension of the refining slag are 2500 kg/m³, 0.2 Pa·s, and 0.386 N/m respectively, the interface tension between the refining slag and the molten steel is 1.336 N/m, the density and viscosity of air are 1.784 kg/m³ and 1.789×10⁻⁵ Pa·s respectively, and the density of argon is 1.784 kg/m³. A volume of fluid (VOF) is utilized to predict a flow of a molten steel phase, a refining slag phase, and an air phase, a discrete phase model (DPM) is utilized to calculate the motion of argon bubbles, and the macroscopic multiphase flow field during the refinement of molten steel is solved using the computational fluid dynamic software FLUENT to obtain a multiphase flow velocity field illustrated in FIG. 3, which includes a direction and a magnitude of velocity and a phase volume fraction.

S2, the inclusions are injected into the molten steel uniformly and randomly. Specifically, the specific regions of the molten steel phase in the macroscopic multiphase flow field during the molten steel refining process are obtained, i.e., the regions where the volume fraction of the molten steel phase is greater than 0.5 are obtained. A density and a diameter of the small-sized alumina inclusions injected into the molten steel phase are respectively determined to be 3500 kg/m³ and 5 micrometer (μm). A number of the inclusions injected into the molten steel phase is determined to be 22000. The inclusions are randomly and uniformly injected into the molten steel phase in the macroscopic multiphase flow field through programming, and this time is taken as the initial time, t₀=0.

S3, the specific condition for capturing the inclusions in the multiphase flow field is determined as follows: when the volume fraction of the slag phase in the cell or grid where the inclusion is located is greater than 0.5, it is determined that the inclusion has been captured by the refining slag.

S4, the motion trajectory of each inclusion in the multiphase flow field during the molten steel refining process is calculated. Specifically, the motion trajectory of the inclusion in the multiphase flow field during the molten steel refining is calculated using the computational fluid dynamics software FLUENT, and the discrete phase model is utilized. The forces acting on the inclusion including the gravity, the buoyancy, the drag force, the virtual mass force and a pressure gradient force are considered, and the motion equation of the inclusion is established through Newton second law. The influence of the turbulence is considered through the random walk model during the molten steel refining process. The motion equation of the inclusion is solved to obtain the acceleration of the inclusion. The acceleration is integrated over time to obtain the velocity of the inclusion. The velocity of the inclusion is integrated over time to obtain the position of the inclusion. The position points of the inclusion at different times are connected to obtain the motion trajectory of the inclusion.

S5, the captured inclusions' information is outputted: the volume fraction of the slag phase in the position of the inclusion is read. When the volume fraction of the slag phase is no greater than 0.5, the inclusion enters to a next time step. When the volume fraction of the slag phase is greater than 0.5, it is determined that the inclusion is captured by the refining slag. This time is taken as a floating time of the inclusion, denoted as t. Relevant information of the inclusions captured by the refining slag is recorded and outputted, including the initial positions of the inclusions, the captured positions of the inclusions, the floating times of the inclusions, etc. The inclusions captured by the refining slag are removed from the computational domain.

S6, the average floating time, the relationship between the removal rate and the floating time and the complete floating time are obtained: the floating times of all of the injected inclusions are calculated by arithmetic average to obtain an average floating time tₐᵥₑ, as follows:

$${t}_{ave} = \frac{1}{N} {\sum }_{i = 1}^{N} {t}_{i} = 175.5 s .$$

The floating times of all of the inclusions are sorted from smallest to largest to obtain the sequence Row, and the floating time t_{m %} corresponding to a removal rate m % is illustrated in Table 1. The complete floating time tₐₗ is defined as a floating time corresponding to a removal rate of 99%, which is: tₐₗ=t_{99%}=873.8 s.

TABLE 1

| Removal rate m % | Number M | Floating time t_{m %} (s) |
|---|---|---|
| 10% | 2200 | 8.4 |
| 20% | 4400 | 26.3 |
| 30% | 6600 | 52.3 |
| 40% | 8800 | 81.8 |
| 50% | 11000 | 115.5 |
| 60% | 13200 | 156.6 |
| 70% | 15400 | 211.4 |
| 80% | 17600 | 289.1 |
| 90% | 19800 | 423.6 |
| 99% | 21780 | 873.8 |

### Embodiment 2

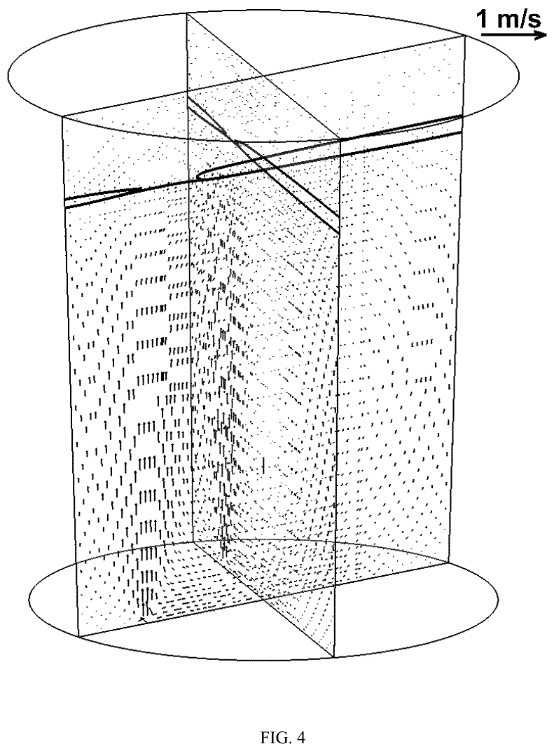

This embodiment mainly focuses on a calculating method of floating time of large-sized alumina inclusions during the ASL, specifically the method includes following steps (as illustrated in FIG. 4).

S1, a macroscopic multiphase flow field in molten steel defining is predicted. The molten steel refining process is the ASL. Specifically, process parameters and operating parameters are as follows: an upper opening diameter of the ladle is 3.92 m, a lower bottom diameter of the ladle is 3.56 m, a height of the ladle is 4.17 m, a height of the molten steel is 3.42 m, a thickness of the refining slag is 0.1 m, coordinates of argon blowing locations are (0.9, 0.7) m and (0.3, −0.95) with two porous plugs, a flow rate of the argon blowing is 6.0 m³/s per porous plug, and a porous plug diameter is 0.1 m. Physical parameters are as follows: the density, viscosity, and surface tension of the molten steel are 7020 kg/m³, 0.0067 Pa·s, and 1.606 N/m respectively, the density, viscosity, and surface tension of the refining slag are 2500 kg/m³, 0.2 Pa s, and 0.386 N/m respectively, the interface tension between the refining slag and the molten steel is 1.336 N/m, the density and viscosity of air are 1.784 kg/m³ and 1.789×10⁻⁵ Pa·s respectively, and the density of argon is 1.784 kg/m³. The VOF is utilized to predict a flow of a molten steel phase, a refining slag phase, and an air phase, the DPM is utilized to calculate the motion of argon bubbles, and the macroscopic multiphase flow field during refinement of the molten steel is solved using the computational fluid dynamic software FLUENT to obtain a multiphase flow velocity field illustrated in FIG. 3, which includes the direction and the magnitude of velocity and the phase volume fraction.

S2, the inclusions are injected into the molten steel uniformly and randomly. Specifically, the specific regions of the molten steel phase in the macroscopic multiphase flow field during the molten steel refining process are obtained, i.e., the regions where the volume fraction of the molten steel phase is greater than 0.5 are obtained. A density and a diameter of the large-sized alumina inclusions injected into the molten steel phase are respectively determined to be 3500 kg/m³ and 200 micrometer (μm). A number of the inclusions injected into the molten steel phase is determined to be 22000. The inclusions are randomly and uniformly injected into the molten steel phase in the macroscopic multiphase flow field through programming, and this time is taken as the initial time, t₀=0.

S3, the specific condition for capturing the inclusions in the multiphase flow field is determined as follows: when the volume fraction of the slag phase in the cell or grid where the inclusion is located is greater than 0.5, it is determined that the inclusion has been captured by the refining slag.

S4, the motion trajectory of each inclusion in the multiphase flow field during the molten steel refining process is calculated. Specifically, the motion trajectory of the inclusion in the multiphase flow field during the molten steel refining is calculated using the computational fluid dynamics software FLUENT, and the discrete phase model is utilized. The forces acting on the inclusion including the gravity, the buoyancy, the drag force, the virtual mass force and a pressure gradient force are considered, and the motion equation of the inclusion is established through Newton second law. The influence of the turbulence is considered through the random walk model during the molten steel refining process. The motion equation of the inclusion is solved to obtain the acceleration of the inclusion. The acceleration is integrated over time to obtain the velocity of the inclusion. The velocity of the inclusion is integrated over time to obtain the position of the inclusion. The position points of the inclusion at different times are connected to obtain the motion trajectory of the inclusion.

S5, the captured inclusions' information is outputted: the volume fraction of the slag phase in the position of the inclusion is read. When the volume fraction of the slag phase is no greater than 0.5, the inclusion enters to a next time step. When the volume fraction of the slag phase is greater than 0.5, it is determined that the inclusion is captured by the refining slag. This time is taken as a floating time of the inclusion, denoted as t. Relevant information of the inclusions captured by the refining slag is recorded and outputted, including the initial positions of the inclusions, the captured positions of the inclusions, the floating times of the inclusions, etc. The inclusions captured by the refining slag are removed from the computational domain.

S6, the average floating time, the relationship between the removal rate and the floating time and the complete floating time are obtained: the floating times of all of the injected inclusions are calculated by arithmetic average to obtain an average floating time tₐᵥₑ, as follows:

$${t}_{ave} = \frac{1}{N} {\sum }_{i = 1}^{N} {t}_{i} = 110.1 s .$$

The floating times of all of the inclusions are sorted from smallest to largest to obtain the sequence Row, and the floating time t_{m %} corresponding to a removal rate m % is illustrated in Table 2. The complete floating time tₐₗ is defined as a floating time corresponding to a removal rate of 99%, which is: tₐₗ=t_{99%}=528.8 s.

TABLE 2

| Removal rate m % | Number M | Floating time t_{m %} (s) |
|---|---|---|
| 10% | 2200 | 6.3 |
| 20% | 4400 | 17.2 |
| 30% | 6600 | 32.7 |
| 40% | 8800 | 52.5 |
| 50% | 11000 | 74.9 |
| 60% | 13200 | 102.0 |
| 70% | 15400 | 136.3 |
| 80% | 17600 | 183.5 |
| 90% | 19800 | 258.8 |
| 99% | 21780 | 528.8 |

The system for implementing the method for predicting inclusion floating times during the refinement of molten steel provided by the present disclosure is capable, on the basis of calculating the flow field during the molten steel refining, of clearly calculating the average floating time and the complete floating time of the inclusions in the molten steel, as well as a relationship curve between the removal rate and the floating time. By implementing the method of the present disclosure, the average floating time and the complete floating time of the inclusions under different refining processes and parameter conditions can be calculated, thereby providing a theoretical basis for the quantitative evaluation and optimization of refining processes and their parameters. Meanwhile, the relationship curve between the removal rate and the floating time can be calculated, thereby determining the refining time of the molten steel during actual production processes, offering theoretical guidance for actual production.

The above description provides a detailed introduction to an embodiment of the system for predicting inclusion floating times during the refinement of molten steel. The explanations of the above embodiments are intended solely to assist in understanding the method of the present disclosure and its core concepts. At the same time, for those skilled in the art, based on the ideas of the present disclosure, there will be variations in specific implementations and applications ranges. Therefore, the contents of this specification should not be construed as a limitation on the present disclosure.

As certain terms are used in the specification and claims to refer to specific components, it should be understood by those skilled in the art that hardware manufacturers may use different terms to refer to the same component. The specification and claims do not distinguish components based on differences in names, but rather based on functional differences between components. The terms “comprising” and “including” as used throughout the specification and claims are open-ended expressions and should be interpreted as “comprising/including but not limited to.” The term “approximately” refers to being within an acceptable range of error, such that those skilled in the art can solve the technical problem within a certain range of error and basically achieve the technical effect. The subsequent description in the specification is intended to illustrate the preferred embodiments of implementing the present disclosure and is not intended to limit the scope of the present disclosure. The scope of protection of the present disclosure should be determined by the appended claims.

It should also be noted that the terms “including,” “comprising,” or any of their variants are intended to encompass a non-exclusive inclusion, such that a product or system including a series of elements not only includes those elements but also includes other elements not explicitly listed, or elements inherent to such a product or system. In the absence of additional restrictions, an element defined by the phrase “including one . . . ” does not exclude the presence of additional identical elements in the product or system including the element.

It should be understood that the term “and/or” used herein is merely a description of the associative relationship between objects, indicating that there can be three relationships, for example, A and/or B, can represent: A alone, both A and B together, or B alone. Additionally, the character “/” in this document generally indicates an “or” relationship between the associated objects before and after it.

The above description shows and describes several preferred embodiments of the present disclosure, but as mentioned above, it should be understood that the present disclosure is not limited to the forms disclosed herein and should not be construed as excluding other embodiments. It can be used in various other combinations, modifications, and environments, and can be modified within the scope of the present disclosure as described herein, through the teachings above or knowledge in the related field. Any modifications and changes made by those skilled in the art that do not depart from the spirit and scope of the present disclosure should be within the protection scope of the appended claims.

1. A method for predicting floating times of inclusions during a refinement of molten steel, comprising following steps:
S1, obtaining process parameters of the refinement of the molten steel, and predicting a macroscopic multiphase flow field during the refinement of the molten steel;
wherein the S1 specifically comprises:
S1.1, determining a process for the refinement of the molten steel;
S1.2, obtaining the process parameters and operating parameters;
S1.3, determining physical parameters of phases of the molten steel, a refining slag, air and argon;
S1.4, establishing a multiphase flow model during the refinement of the molten steel, wherein the multiphase flow model comprises at least a molten steel phase and a refining slag phase; and
S1.5, solving the multiphase flow model to calculate and obtain the macroscopic multiphase flow field, wherein flow field data of the macroscopic multiphase flow field comprises at least a velocity, a turbulent energy, a dissipation rate of the turbulent energy, and volume fractions of the molten steel phase and the refining slag phase;
S2, injecting the inclusions into the molten steel uniformly and randomly according to the multiphase flow field obtained in the S1;
wherein the S2 specifically comprises:
S2.1, obtaining regions of the molten steel phase in the macroscopic multiphase flow field during the refinement of the molten steel;
S2.2, determining a density and a diameter of the inclusions injected into the molten steel phase;
S2.3, determining a number N of the inclusions injected into the molten steel phase, wherein 10⁴<N<10⁵; and
S2.4, injecting the inclusions into the molten steel phase in the macroscopic multiphase flow field randomly and uniformly, and taking this time as an initial time, t₀=0;
S3, determining a capture condition of the inclusions injected into the multiphase flow field in the S2;
S4, calculating a motion trajectory of each inclusion injected into the multiphase flow field in the S2;
wherein the S4 specifically comprises:
S4.1, taking random and uniform distribution of the inclusions in the molten steel phase in the S2.4 as an initial condition to calculate the motion trajectory of each inclusion in the multiphase flow field during the refinement of the molten steel;
S4.2, utilizing a discrete phase model to calculate the motion trajectory of each inclusion, and a motion equation of the inclusions being expressed by Newton's second law in the discrete phase model; solving an acceleration of each inclusion through forces acted on each inclusion, including a gravity, a buoyancy, a drag force, a virtual mass force, and a pressure gradient force; and describing influences of turbulences by a random walk model in the motion equation of the inclusions during the refinement of the molten steel;
S4.3, integrating the acceleration of each inclusion solved in the S4.2 over time to obtain a velocity of each inclusion; and
S4.4, integrating the velocity of each inclusion obtained in the S4.3 to obtain a position of each inclusion; and connecting position points of each inclusion at different times to obtain the motion trajectory of each inclusion;
S5, outputting information of captured inclusions and removing the captured inclusions, when the motion trajectories of the inclusions in the S4 meet the capture condition of the inclusions in the S3;
wherein the S5 specifically comprises:
S5.1, obtaining a volume fraction of a slag phase in the position of each inclusion calculated in the S4.4;
S5.2, comparing the volume fraction of the slag phase in the position of each inclusion obtained in the S5.1 and a volume fraction of the slag phase determined in the S3;
S5.3, making the inclusion enter a next time step when the volume fraction of the slag phase in the position of the inclusion obtained in the S5.1 is no greater than 0.5; or determining the inclusion being captured by the refining slag when the volume fraction of the slag phase in the position of the inclusion obtained in the S5.1 is greater than 0.5, and taking this time as a floating time of the inclusion, denoted as t;
S5.4, recording and outputting relevant information of the inclusions captured by the refining slag, wherein the relevant information of the inclusions captured by the refining slag comprises initial positions of the inclusions, captured positions of the inclusions, and the floating times of the inclusions; and
S5.5, removing the inclusions captured by the refining slag from a computational domain; and
S6, analyzing the information of the captured inclusions obtained in the S5 to obtain an average floating time, a relationship between a removal rate and a floating time, and a complete floating time;
wherein the S6 specifically comprises:
S6.1, performing arithmetic average on the floating times of all of the inclusions to obtain an average floating time tₐᵥₑ through the following formula:
$${t}_{ave} = \frac{1}{N} {\sum }_{i = 1}^{N} {t}_{i} ;$$
where N represents a number of the inclusions, tᵢ represents a floating time of an i-th inclusion;
S6.2, letting M=N×m % when the removal rate of the inclusions is m %;
6.3, sorting the floating times of all of the inclusions from smallest to largest to obtain a sequence Row;
S6.4, determining a floating time t_{m %} corresponding to the removal rate m % as a M-th value of the sequence Row, which is:
t_{m %}=Row[M]; and
S6.5, determining the complete floating time tₐₗ as a floating time corresponding to a removal rate of 99%, which is:
tₐₗ=t_{99%}.

2. (canceled)

3. The method as claimed in claim 1, wherein the process for the refinement of the molten steel in the S1.1 comprises: argon-stirred ladle, ladle furnace (LF) refining, ruhrstahl heraeus (RH) refining, or vacuum degassing (VD) refining.

4. (canceled)

5. The method as claimed in claim 1, wherein the step of determining a capture condition of the inclusions injected into the multiphase flow field in the S3 specifically comprises: when a volume fraction of a slag phase in a cell or a grid where one of the inclusions is located is greater than 0.5, the one of the inclusions is determined to be captured by a refining slag.

6-8. (canceled)

9. A system implementing the method for predicting the floating times of the inclusions during the refinement of the molten steel as claimed in claim 1, wherein the system comprises:
a molten steel refining multiphase flow module, configured to obtain the process parameters of the refinement of the molten steel, and predict the macroscopic multiphase flow field during the refinement of the molten steel;
an inclusion floating motion analysis module, configured to calculate the motion trajectories of the inclusions and capture processes of the inclusions according to the macroscopic multiphase flow field during the refinement of the molten steel, and to output the information of the captured inclusions; and
a data analysis module, configured to calculate to obtain the average floating time, the relationship of the removal rate and the floating time, and the complete floating time according to the information of the captured inclusions.

10. A non-transitory computer-readable storage medium, wherein the non-transitory computer-readable storage medium is stored with a computer program; and the computer program is configured to be executed by a processor to implement the method as claimed in claim 1.
